(19) United States
(12) Patent Application Publication
(10) Pub. No.: US 2008/0201180 A1
(43) Pub. Date: Aug. 21, 2008

(54) Facilitating environmental resource and/or energy management on farms

(76) Inventor: Mark L. Green, St. Louis, MO (US)

Correspondence Address: HARNESS, DICKEY, & PIERCE, P.L.C, 7700 Bonhomme, Suite 400, ST. LOUIS, MO, 63105, US

(21) Appl. No.: 11/707,847

(22) Filed: Feb. 16, 2007

(51) Int. Cl. G06Q 10/00

(52) U.S. Cl. 705/7; 705/1

(57) ABSTRACT

A method of facilitating environmental resource and/or energy management on farms. From each of a plurality of farms, data is collected relating to environmental resource and/or energy management on the farm. For each farm, at least some of the data is monitored to provide a verification of one or more conditions related to a goal of the environmental resource and/or energy management. For one of the farms, the verification is communicated to a party unaffiliated with the one of the farms.

### FIELD

The present disclosure relates to environmental resource and/or energy management and more particularly (but not exclusively) to facilitating environmental resource management and/or energy management on farms while compiling environmental resource and/or energy management-related data for use by parties not affiliated with the farms.

### BACKGROUND

The statements in this section merely provide background information related to the present disclosure and may not constitute prior art.

There are many opportunities in deploying renewable energy solutions for the agriculture industry. Enormous opportunities exist for developing rural America's clean energy resources, including bioenergy (the production of electricity, useable heat, or liquid fuels from biomass), wind, solar, and energy conservation. The world is waking up to the benefits of renewable energy and the real necessity to building a sustainable energy independent economy. The renewable energy marketplace, however, is very fragmented and highly complex. Thus it can be difficult for most farmers to assess the subject of renewable energy products and activities with any assurance that they have sufficiently covered the topic.

### SUMMARY

The present disclosure, in one implementation, is directed to a method of facilitating environmental resource and/or energy management on farms. From each of a plurality of farms, data is collected relating to environmental resource and/or energy management on the farm. For each farm, at least some of the data is monitored to provide a verification of one or more conditions related to a goal of the environmental resource and/or energy management. For one of the farms, the verification is communicated to a party unaffiliated with the one of the farms.

In another implementation, a system for facilitating environmental resource and/or energy management on farms includes means for collecting, from each of a plurality of farms, data relating to environmental resource and/or energy management on the farm. The system includes means for monitoring at least some of the data for each farm to provide a verification of one or more conditions on each farm related to a goal of the environmental resource and/or energy management, and means for communicating the verification for one of the farms to a party unaffiliated with the one of the farms.

In another implementation, the disclosure is directed to a method of compiling farm environmental resource and/or energy management data for use within the agricultural industry. From one or more farms, data is collected relating to environmental resource and/or energy management on the farm(s). At least some of the collected data is processed to obtain one or more solutions for improving environmental resource and/or energy management on the farm(s). The collected data and/or solutions are made available to at least one party unaffiliated with the farm(s).

In still another implementation, a method of compiling farm energy data for use within the agricultural industry includes collecting, from one or more farms, data relating to energy usage and/or energy production on the farm(s). The collected data is processed to produce one or more energy solutions for improving energy production and/or usage on the farm(s). The collected data and/or the energy solutions are made available to at least one third party unaffiliated with the farm(s).

In still another implementation, a computer system for facilitating improvements to farm energy production and/or usage includes at least one processor and memory configured to use energy audits of a plurality of on-farm energy applications in a plurality of farming industry segments to provide one or more models for each application. The processor and memory are configured to receive data descriptive of one or more energy-related conditions at a farm, and based on the conditions, select and use one or more of the models to evaluate the data relative to one or more energy-related resources in connection with which one or more benefits may be obtainable by a farmer of the farm. The processor and memory are configured to, based on the evaluating, output a scenario for implementing the one or more energy-related resources and obtaining the one or more benefits.

In still another implementation, the disclosure is directed to a web-based method of facilitating improvements to farm energy production and/or usage. The method includes receiving data descriptive of one or more energy-related conditions at a farm. Based on a farming industry segment to which the conditions are related, one or more models are selected from a plurality of models descriptive of a plurality of on-farm energy applications. The data is input to the model(s) to evaluate potential use of one or more energy-related resources in connection with which one or more benefits may be obtainable by the farmer. Based on the evaluating, a scenario is output for implementing the energy-related resource(s) and obtaining the benefit(s).

In yet another implementation, the disclosure is directed to a web-based method of facilitating improvements to environmental resource management and/or energy management on farms. The method includes receiving data descriptive of one or more environmental resource- and/or energy-management-related conditions at a farm. Based on a farming industry segment to which the conditions are related, one or more models are selected from a plurality of models descriptive of a plurality of on-farm environmental resource and/or energy management applications. The data is input to the model(s) to evaluate potential use of one or more environmental-resource-management-related and/or energy-management-related resources in connection with which one or more benefits may be obtainable by a farmer of the farm. Based on the evaluating, a scenario is output for implementing the environmental-resource-management-related and/or energy-management-related resource(s) and obtaining the benefit(s).

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a flow diagram of a method of facilitating environmental resource and/or energy management on farms in accordance with one implementation of the disclosure;

FIG. 2 is a diagram of a system for facilitating environmental resource and/or energy management on farms in accordance with one implementation of the disclosure;

FIG. 3 is a flow diagram of a method of compiling farm environmental resource and/or energy management data for use within the agricultural industry in accordance with one implementation of the disclosure;

FIG. 4 is a system for producing input and output scenarios in accordance with one implementation of the disclosure;

FIG. 5A is an illustration of input for a project specification in accordance with one implementation of the disclosure;

FIGS. 5B-5E are illustrations of output for the project specification input shown in FIG. 5A; and

FIG. 6 is a flow diagram of a method of facilitating improvements to environmental resource and/or energy management on farms in accordance with one implementation of the disclosure.

### DETAILED DESCRIPTION

The following description is merely exemplary in nature and is not intended to limit the present disclosure, application, or uses.

In various implementations of the disclosure, a single system may be used to identify environmental resource and/or energy management-related products and applications for a farm and/or to provide monitoring of such applications for a plurality of farms. The system collects data relating to environmental resource and/or energy management on farms, e.g., data as to resource usage, monitoring, and farm profiling. The system may store and make such data available, e.g., to the farmer and to party(s) unaffiliated with the farmer, e.g., to the energy and/or agriculture industries. It should be noted generally that energy is frequently regarded as an environmental resource. Thus environmental resource management and energy management can overlap. Accordingly, although the terms “environmental resource management” and “energy management” may be used individually in this disclosure and in the claims, it should be understood that the use of either term can include both terms.

Some ways in which renewable energy can be made to work in agriculture energy applications are as follows: providing hot water for home and farm use; pumping water for livestock; powering automatic gate openers; aeration fans in grain storage bins and automatic supplement feeders; powering security and task lighting, as well as entrance signs; powering buildings and operating labor-saving equipment far from utility lines; helping protect users from electricity price spikes, brownouts, rolling blackouts and other grid-related reliability and supply security issues; avoiding the high costs of extending power lines to remote locations; and producing 5 kilowatts to 5 megawatts of power using small modular biomass power systems.

It is contemplated that various devices, products and resources can be proposed to farmers in relation to environmental resource and/or energy management. Some of the areas of renewable energy that may be addressed in various implementations of the present disclosure include the following areas.

### Wind Turbines

A typical small wind system has a wind turbine mounted on a tower, supplementing a home or farm's energy needs whenever the wind is blowing. States with net metering programs allow wind energy producers to sell excess energy back to the utility. Besides installing small wind turbines to meet their own energy needs, many rural landowners lease land to power companies for large-scale wind projects. Other landowners have pooled their resources to start cooperatively-owned wind projects. Farmers and ranchers are in a unique position to benefit from the growth in the wind industry. To tap this market, farmers can, e.g., lease land to wind developers, use the wind to generate power for their farms, and/or become wind power producers themselves.

### Water Pumping

It has been observed that the electrical energy produced by a 250 kW solar electric system can provide 42% savings on annual water pumping electrical expenses. Savings are projected to increase over time as the lease price stays fixed and the utility cost of energy continues to rise.

### Crop Drying

Drying crops and grains by simply exposing them to the heat of the sun is one of the oldest and most widely used applications of solar energy. But allowing crops to dry naturally in the field exposes them to the elements and contamination, as well as birds and insects. Modern solar crop driers are still very simple, but are more effective and hygienic. The basic components of a solar dryer are an enclosure or shed, screened drying racks or trays, and a solar collector. The collector can be as simple as a glazed box with a dark colored interior to absorb the solar energy that heats air. The heated air in the collector moves, by natural convection or a fan, up through the material to be dried.

### Water Heating

Another use of solar energy for increased on-farm productivity is water heating—particularly in livestock operations. In the raising of poultry, periodic cleaning of pens and equipment is necessary. Simple solar water heaters are available to provide low to medium temperature hot water for this purpose. These systems entail the use of a solar collector, a storage tank, plumbing and pumps. Commercially available systems are accessible and can offer simple installation.

### Irrigating Crops/Watering Livestock

Sunlight can also generate electricity. Photovoltaic (PV) panels are often a cheaper option than new electric lines for providing power to remote locations. And because they require no fuel and have no moving parts, they are more convenient to operate and maintain than diesel or gasoline generators. In some areas, the distance from a power source, at which PV becomes more economical than new transformers, and electric lines is surprisingly short—often as little as 50 feet. PV systems can be a highly reliable and low-maintenance option for electric fences, lights, and water pumps. Although current prices for solar panels make them too expensive for most crop irrigation systems, photovoltaic systems can be economical for remote livestock water supply, pond aeration, and small irrigation systems. In addition, the cost of PV is projected to decline significantly over time, which may make more applications cost-effective.

### Solar Thermal

Solar thermal electric capacity has been predicted to increase worldwide. The cost of building, operating, and maintaining solar thermal electric systems has decreased dramatically—in some cases by a factor of 10—during the 1980s and 90s and is expected to continue dropping. Solar-thermal designs may be economically competitive with some conventional electricity-generating technologies. By 2010, some solar thermal electric technologies could be producing electricity at $0.06 to $0.07 per kilowatt hour (kWh).

It should be noted that the field of environmental resource and/or energy management is expanding and that implementations of the disclosure could be practiced in connection with other or additional areas. Goals of environmental resource and/or energy management include but are not limited to carbon emission reduction, energy production, energy conservation, energy use reduction, improvement of air quality, improvement of water quality, improvement of soil conditions, and sustainability.

In various implementations of the disclosure, a farmer may be provided with a substantially comprehensive plan for managing energy and/or other environmental resources. A farmer may obtain, through a web-based system, an assessment that includes, e.g., integrated energy analysis and one or more proposed management solutions which include description of projected return on investment (ROI). Additionally, various embodiments can provide identification of source(s) of environmental resource management-related resources. Benefits such as state and federal grants that may be available to the farmer can be identified, and on-going monitoring of conditions relating to environmental resource management-related resources can be performed.

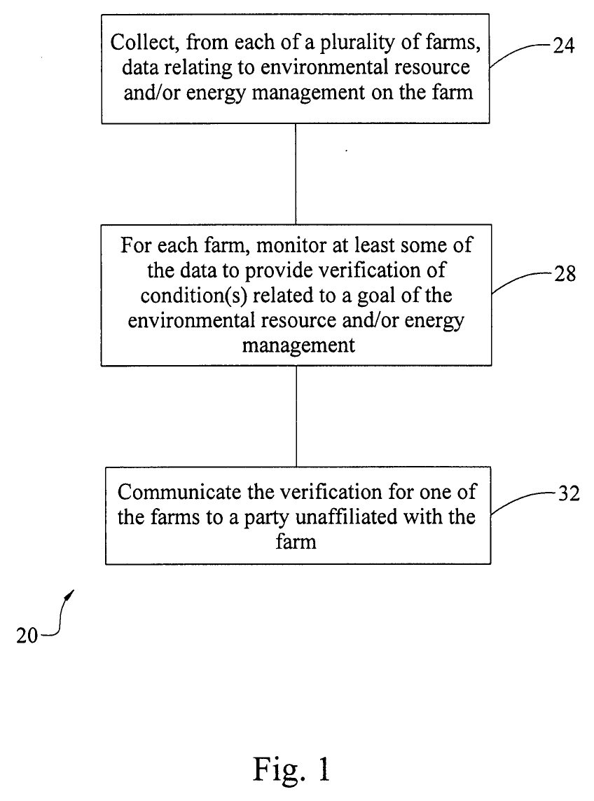

A method of facilitating environmental resource and/or energy management on farms is indicated generally in FIG. 1 by reference number 20. In step 24, from each of a plurality of farms, data is collected relating to environmental resource and/or energy management on the farm. In step 28, for each farm, at least some of the collected data is monitored to provide a verification of one or more conditions related to a goal of the environmental resource and/or energy management. In step 32, the verification for one of the farms is communicated to a party unaffiliated with the farm.

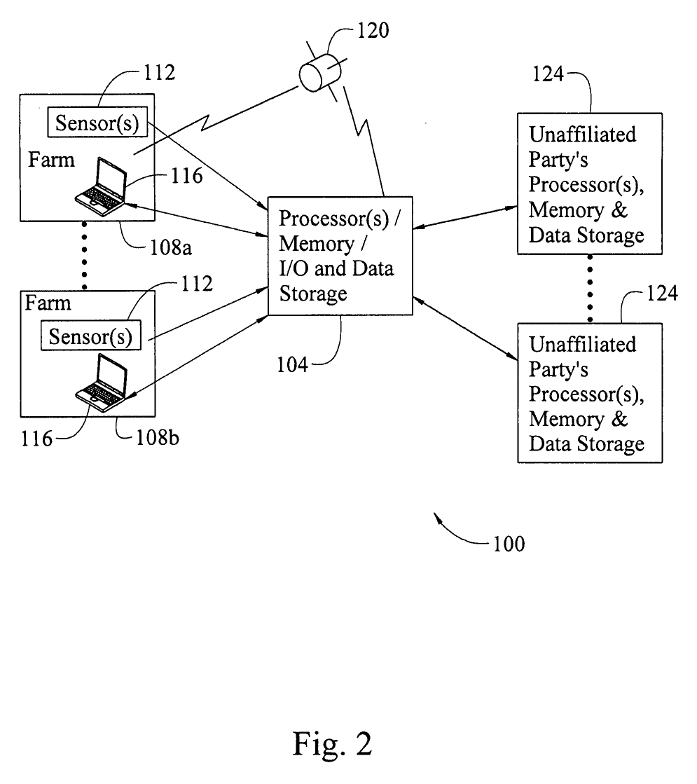

A system for facilitating environmental resource and/or energy management on farms is indicated generally in FIG. 2 by reference number 100. The system 100 includes one or more processors, memory, data storage and input/output ports/device(s), indicated collectively in FIG. 2 by reference number 104 and referred to as computer 104. It should be understood that the computer 104 could have many different configurations, could include components different from and/or in addition to those shown in FIG. 2. Further, the computer 104 could include components distributed in one or more locations remote from other computer 104 component(s). Still further, there could be more than one computer 104 in some configurations. In various implementations the computer 104 includes one or more gateways to the Internet (not shown).

The computer 104 collects data relating to environmental resource and/or energy management on each of one or more farms 108 (two farms 108a and 108b being shown in FIG. 2). Specifically and for example, one or more sensors 112 installed at the farms 108a and 108b are configured to sense information pertinent to environmental resource and/or energy management and transmit the information to the computer 104. It should be understood that “sensor” is used broadly to refer to and include a wide variety of devices. Such devices may include, e.g., inverters that may be connected in an electrical system to sense energy use, other kinds of energy sensors, temperature sensors, usage meters, light sensors, wind speed and/or direction sensors, motion detectors, heat sensors, water sensors, emission sensors, analog and digital signal receivers, cameras, satellites, etc.

In addition to (or in some cases, instead of) receiving sensor information, the computer 104 may receive data from a farmer and/or other party affiliated with a farm 108. For example, farmers of the farms 108a and 108b use computers 116 to communicate with the computer 104 via the Internet or other network. It also is contemplated that a farmer could convey information to the computer 104 in other ways, for example, by telephone, cell phone, etc. In some implementations, a farmer, could convey voice information that would be transcribed into digital form for input to the computer 104.

In the present exemplary implementation, the farmers of the farms 108a and 108b use the system 100 to track and verify energy usage on the farms 108a and 108b. Accordingly, the computer 104 monitors data received from one or more inverters 112 on each farm to provide verification of energy usage on each farm.

Additionally, the farmer of the farm 108a, who wishes to sell carbon offsets, has installed a plurality of wind turbines (not shown) on the farm 108a. The farmer of the farm 108a has used his/her computer 116 to send data via the Internet to the computer 104 descriptive of the turbines, including, e.g., their locations, their power rating, etc. The farmer of the farm 108a uses the system 100 to track and verify the existence of carbon offsets. Accordingly, a satellite 120 of the system 100 monitors the turbines, e.g., by acquiring imagery confirming the existence, location(s) and operational status of the turbines. The satellite 120 transmits the monitoring data to the computer 104, which is configured to provide verification as to the status of the turbines. As further described below, the computer is also configured to communicate the verification to a computer 124 of a party unaffiliated with the one of the farms, for example, a broker of carbon credits. The satellite 120 may be used to monitor other or additional environmental resource and/or energy management projects. For example, the satellite 120 may be used to monitor no-till usage of land in connection with carbon offsets.

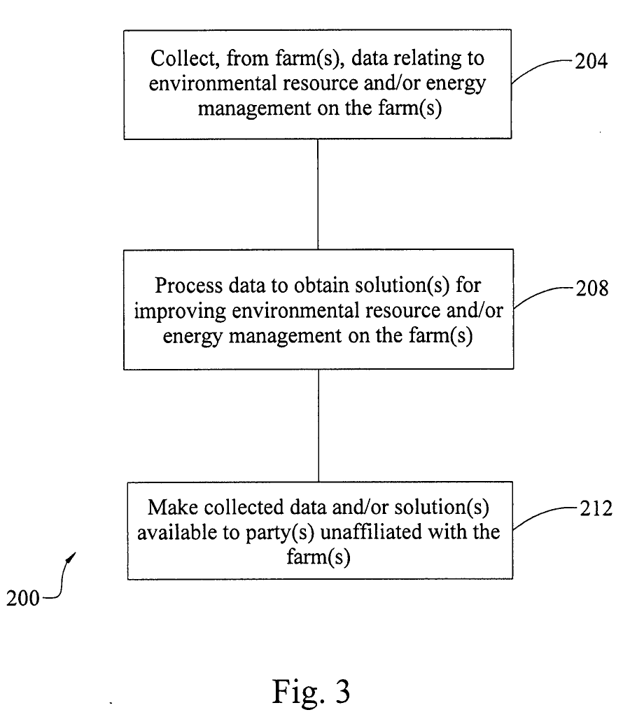

The system 100 may be used in one implementation of a method of compiling farm environmental resource and/or energy management data for use, e.g., within the agricultural industry. Such a method is indicated generally in FIG. 3 by reference number 200. In step 204, data is collected from one or more farms relating to environmental resource and/or energy management on the farm(s). In step 208, at least some of the collected data is processed to obtain one or more solutions for improving environmental resource and/or energy management on the farm(s). In step 212, the collected data and/or solutions are made available to at least one party unaffiliated with the farm(s).

More specifically and referring again to FIG. 2, information may be collected by the system 100 from farmers of the farms 108, e.g., in the following manner. A farmer may use a computer 116 and the Internet to provide general demographic information to the computer 104, e.g., location, farm/business name, first and last names, state, city, county, etc. The farmer, e.g., upon prompting by the computer 104, may provide input specifying an environmental resource management-related problem and/or need desired to be resolved. The farmer also may provide input specifying data for use by the system 100 to determine what incentives are available in the farm's geographic area.

The computer 104 processes the input data, as further described below, to obtain a proposed solution for resolving the stated problem and/or need. The computer 104 also may determine whether benefit(s) may be available to the farmer for implementing the proposed solution and if so, which benefit(s). In some implementations, benefit(s) may include, e.g., a savings, a loan, payment on a lease, a grant, a tax credit, an energy sale, and/or a payment for a carbon credit. It should be noted generally that various benefits may be available in connection with various environmental resource management-related products and/or projects. In the present example, the computer 104 determines whether federal, state and/or local grants and/or tax credits may be available in the area of the farm, and if so, in what amount(s) in connection with the proposed solution.

Alternatively, a farmer, e.g., upon prompting by the computer 104, may provide input specifying a desire to install an environmental resource management-related resource, e.g., a renewable energy product. The farmer also may provide input specifying data for use by the system 100 to determine what incentives are available in the farm's geographic area. The farmer provides data specifying and/or describing the resource, e.g., the size of the project and/or product he/she wishes to install. The computer 104 processes the input data provided by the farmer, as further described below, to obtain a solution that describes, e.g., product(s) to install and costs and available incentives for installing the desired resource. The computer 104 may determine, e.g., whether benefit(s) may be available, e.g., whether (and if so, which) federal, state and/or local grants and/or tax credits are available in the area of the farm.

If the farmer wishes to file an application for a benefit identified by the system 100, he/she may access an appropriate application form via the system 100. The computer 104 may use data previously provided by the farmer to populate the form and/or may prompt the farmer to provide information for the form. The farmer may instruct the system 100 to transmit the completed form, e.g., via the Internet, to a computer 124 of the party via which the particular benefit may be available. The system 100 sends the form to the appropriate Internet address, confirms receipt of the form by the appropriate party, and subsequently may keep track of, and provide information to the farmer pertaining to, the application. The system 100 may maintain an account for the farmer, who may log into his/her account at virtually any time to view, among other items, the status of the application.

The system 100 may use data provided by one or more sources to determine whether and which incentives may be available for a proposed solution. One such source is a database available at http://www.dsireusa.org/. In some implementations in which a farmer submits an application to a potential lender for a loan, the lender may be affiliated with a provider of the system 100. The application form submitted by the farmer may propose, and the lender may agree, that a note for the loan be secured against product on the farm, e.g., a tractor or combine, other than energy-related resources. In such manner, the lender may have collateral that may be considered to have a higher value and security than what traditionally has been accorded to, e.g., solar or wind powered products on a micro generation level. Such an arrangement also allows a lender to avoid having to repossess an energy application from a farm in default. Such repossessions can be distasteful to a lender where excessively punitive to a farmer, e.g., where they result in severe loss of animals and/or crops.

Additionally or alternatively, a farmer may be prompted by the system 100 to submit a loan application via the system 100 to the United States Department of Agriculture (USDA). Loan forms used by the system 100 may be obtained, for example, at http://www.rurdev.usda.gov/ia/rbs-forms.html.

In some implementations, the system 100 makes an “on the spot” loan request worksheet available to a farmer. The computer 104 uses data entered by the farmer to populate the worksheet. The computer 104 may send the form to a computer 124 of a lender. In some implementations, the lender replies to the computer 104 with an approval or denial of the loan request within a short time, e.g., within 15 minutes, after receipt of the form.

As previously discussed, carbon credit tracking and reporting may be performed via the system 100. In some implementations, an inverter with software for real time tracking and reporting of carbon offsets may be installed on a farm. One example of tracking software is described at www.fatspaniel.com . At his/her online account, a farmer may view, e.g., the status of farm energy usage as well as his/her energy usage resource purchase and finance history through the system 100. The farmer may sell credit offsets for cash by exchanging them through the open market via a party unaffiliated with the farm, specifically and for example, a carbon credit broker affiliated with a provider of the system 100. Verification of carbon credits may be performed, e.g., via the inverter tracking software and carbon footprint mapping software further described below. In some implementations, the system 100 provides a farmer with documentation needed for the filing of carbon credits. Specifically and for example, the farmer may be prompted by the computer 104 to input data into carbon credit forms for submission to a carbon credit broker. The system 100 may submit the completed forms via the Internet to the broker.

As previously mentioned, the computer 104 may process input data provided by a farmer to obtain a proposed solution to an environmental resource and/or energy management-related problem or request. Based on the input data, the computer 104 identifies a farming industry segment to which the problem or request is related. Thus the computer 104 selects one from a plurality of segments, e.g., from beef, dairy, grain, poultry, swine, horticulture, and specialty crops (e.g., particular fruit or vegetable crops). In one implementation, through on-farm research and application analysis, a methodology and mapping process is provided for modeling manufacturing/production energy usage and gaps. Such research and analysis data may be formulated into a web-based application that produces input and output scenarios, e.g., for clean energy solutions and recommendations.

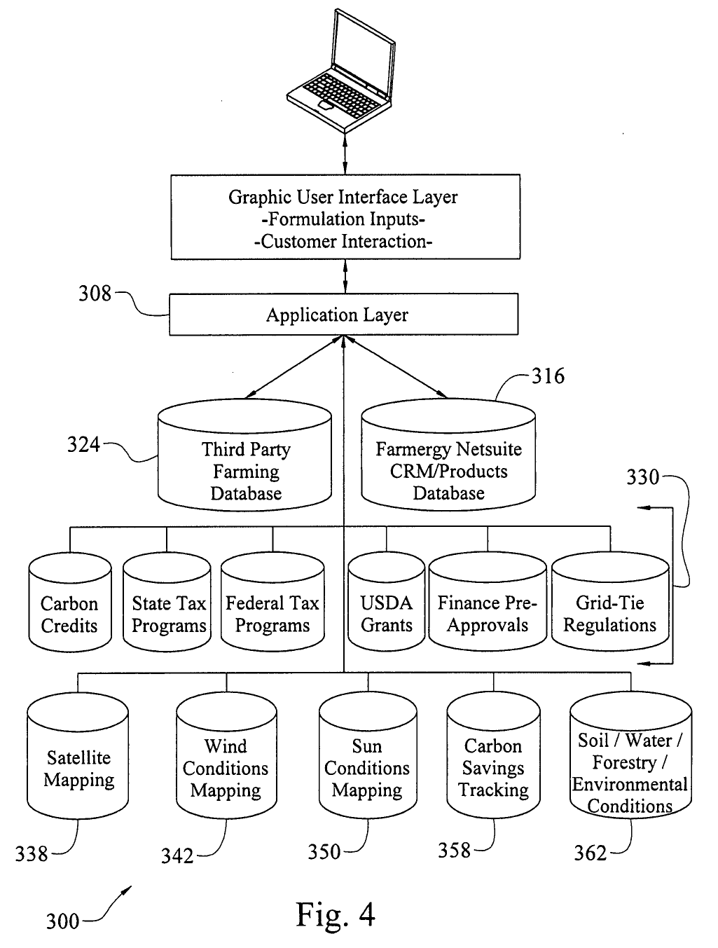

A diagram of one implementation of a system for producing input and output scenarios is indicated generally in FIG. 4 by reference number 300. In the present exemplary implementation, the system 300 is included in the system 100 shown in FIG. 2 and resides on the computer 104. The system 300 receives input from the farm computer 116. An application layer 308 communicates with a supply chain management database 316, from which recommended products and solutions may be retrieved based, e.g., on key words, tagging technology for specifications, and metadata. Profiling data, monitoring data, proposed environmental resource management-related solutions, and other data collected from farms via the system 100 is stored in a farming database 324 and accessed by the application layer 308. Additionally, the application layer 308 communicates with databases 330 to retrieve inputs relating to availability of benefits such as financing options, e.g., through one or more preferred lenders and/or brokers. Potential benefits also could include, e.g., carbon credits, grants, savings, lease payments, tax credits, and energy sales.

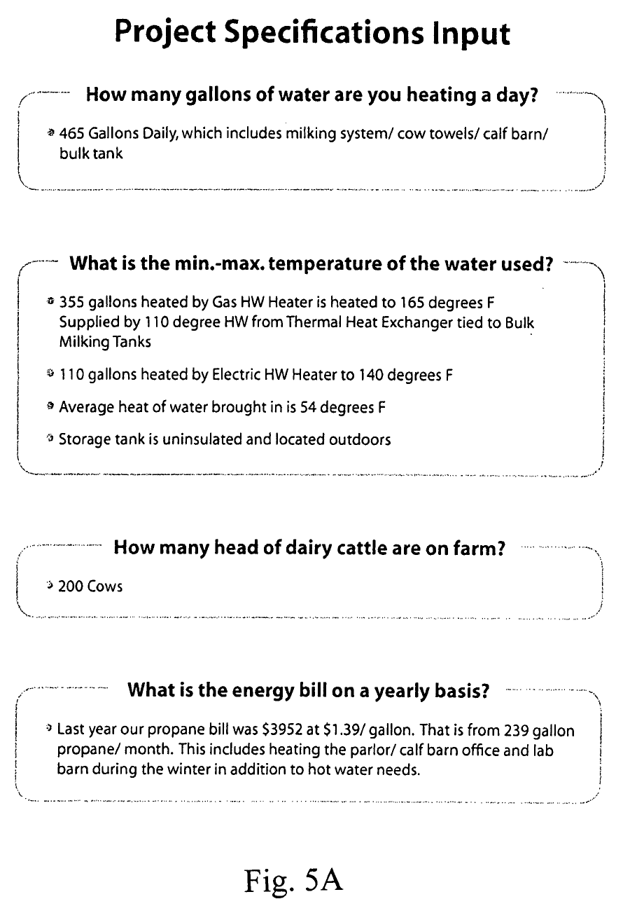

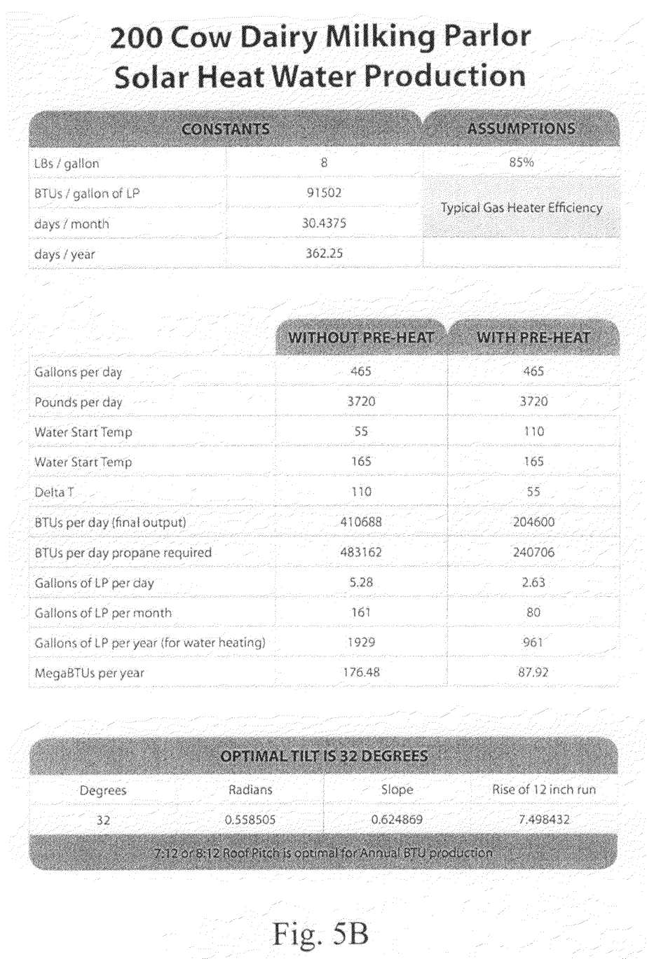

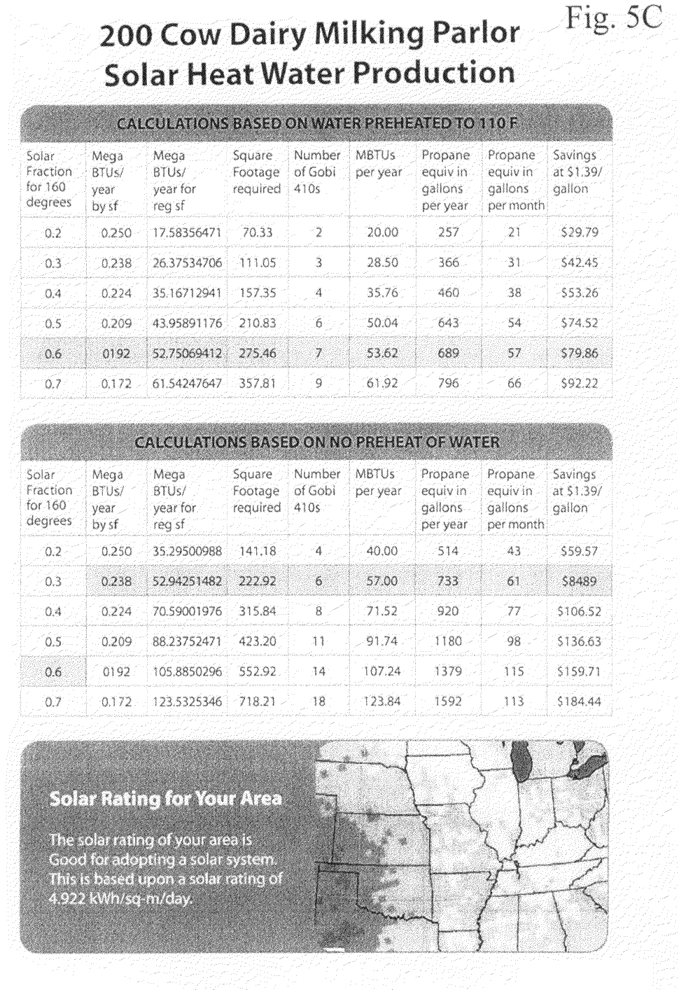

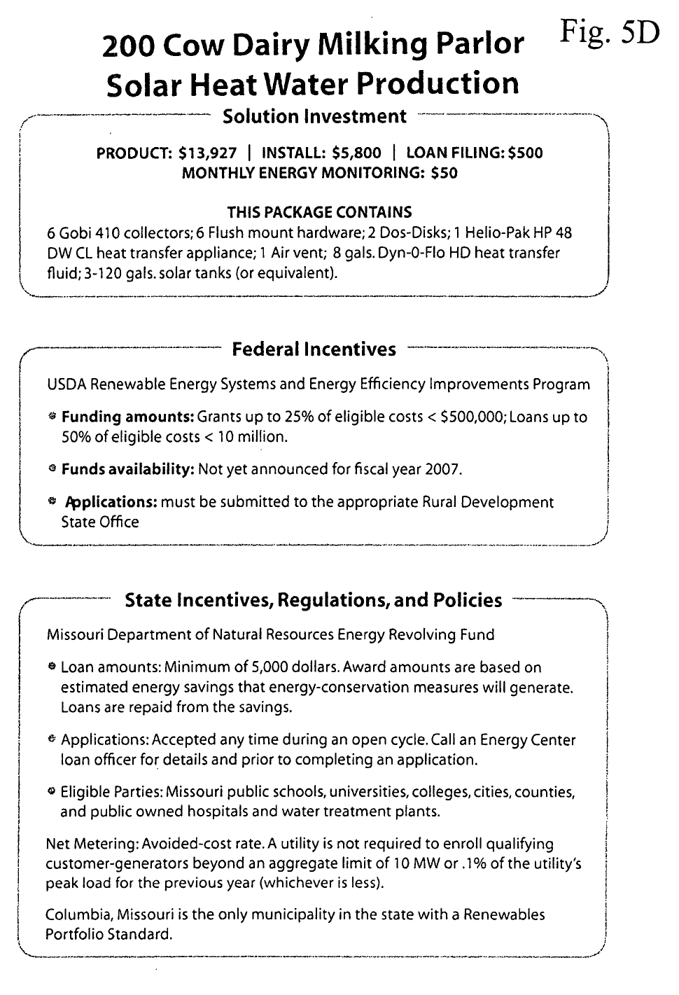

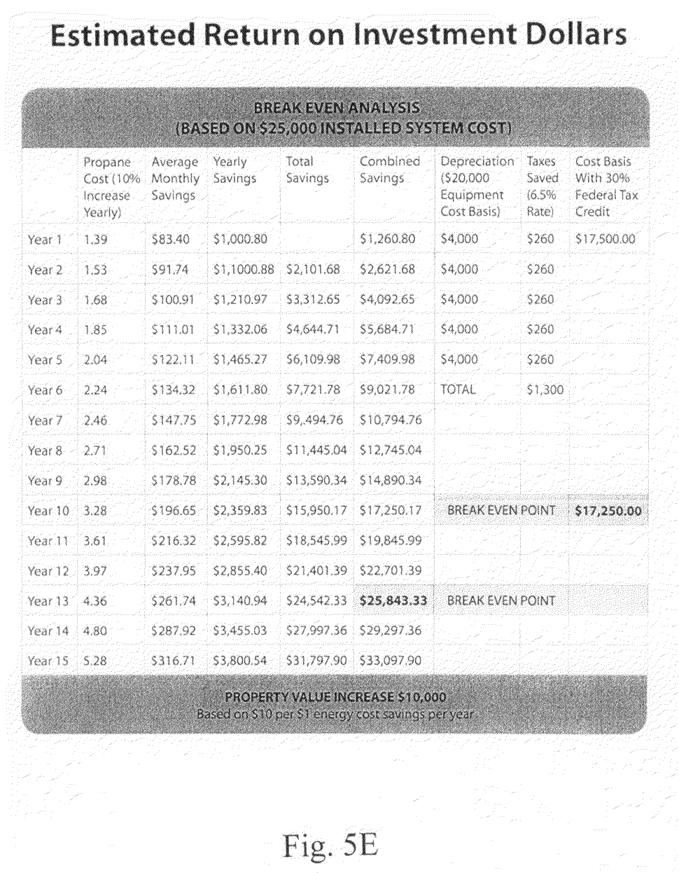

A plurality of models are available to the application layer 308 which describe a plurality of on-farm application processes. Processes are modeled for applications in each industry segment mentioned above. Additionally, models are provided for processes such as satellite mapping 338, wind conditions mapping 342, sun conditions mapping 350, carbon savings tracking 358, and soil/water/forestry/environmental conditions 362. Models thus may be provided for various conditions including but not limited to till conditions, air quality, carbon footprint, water quality, and emissions. Using such models, the system 300 can evaluate data input by the farmer relative to one or more resources, e.g., described in the database 316, in connection with which one or more benefits may be obtainable by the farmer. The system 300 may generate a report that includes information substantially as shown in project specification inputs and outputs shown in FIGS. 5A-5E.

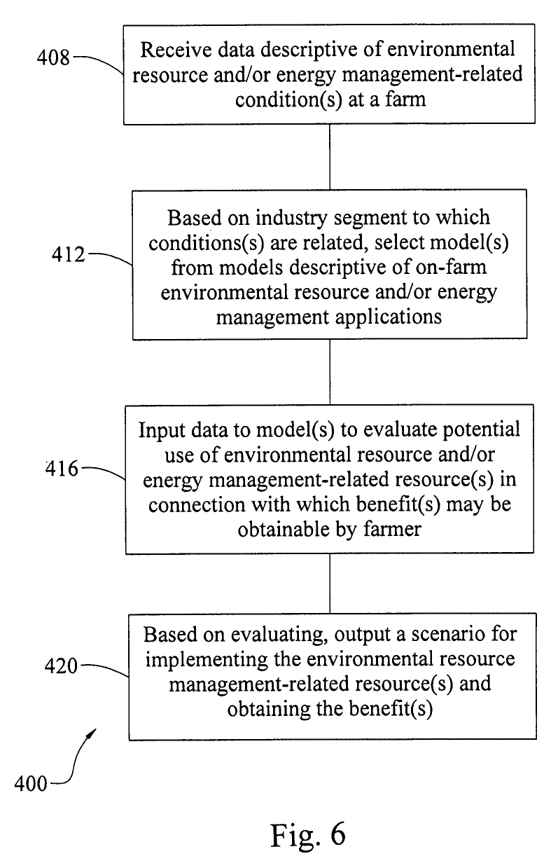

Accordingly, in some implementations, the computer 104 may perform a method indicated generally in FIG. 6 by reference number 400. In step 408 the computer 104 receives, e.g., from the farmer, data descriptive of one or more environmental resource and/or energy management-related conditions at a farm. In step 412, the computer 104 selects one or more models from a plurality of models descriptive of on-farm environmental resource and/or energy management-related applications. The model selection is made based on an industry segment to which the condition(s) are related. In step 416, the computer 104 inputs the data to the model(s) to evaluate potential use of environmental resource and/or energy management-related resource(s) in connection with which benefit(s) may be obtainable by the farmer. In step 420, based on the evaluating, the computer 104 outputs a scenario for implementing the environmental resource and/or energy management-related resource(s) and obtaining the benefit(s).

Profiling data, monitoring data, proposed environmental resource management-related solutions, and other data collected from farms via the system 100 may be made available for use, e.g., by marketers of products targeting the agriculture industry and by other parties not affiliated with the farms. The data may be, e.g., stored in the database 324 and made available by subscription over the Internet, via which subscribers could search and/or compile reports from the database 324.

Various implementations of the disclosure can provide a feasibility profile of a current state of energy usage as it pertains to a farm. Integrated data points can be provided to a farm from satellite imaging, wind mapping services, sun/solar condition services. Farm scenarios for best and worst case clean energy product solutions can be provided. Automated matching of clean energy products from the database 316 can be provided responsive to the profiling of a farm and conditions on the farm. Automated feeds from federal, state and local governments of available grants and incentives to the farmer can be integrated with implementation of clean energy products. Various systems in accordance with the disclosure can pre-select benefits, based on the collection of profiling data, down to the local level. Such a system can integrate with a carbon credit brokerage and market to provide a farmer with a view of credits available for a clean energy solution. A comprehensive clean energy solution plan/proposal can be provided for a farmer/customer. Such a proposal can be relevant to banks and to the issuance of grants, tax credits, carbon credits and, most importantly, to the farmer in his/her decision process. The foregoing system can display on-farm energy savings tracking data and carbon reduction data, in substantially real time, as well as a report as to ROI, in a farmer's web-accessible profile for validation and verification by the farmer. Data can be stored for multiple industry usages, including the transmittal of data back to carbon credit brokerage houses on behalf of the farmer.

The foregoing systems and methods can reduce and stabilize energy costs, and are cost effective when, e.g., tax credits and energy metering are considered. The foregoing systems and methods provide efficient use of solar, wind and backup power (off grid) and can provide turnkey management of energy needs. Farmers can be provided with a comprehensive full service turn-key clean energy solution that will save them time and money.

1. A method of facilitating environmental resource energy management on farms, the method comprising:
for each of a plurality of farms, collecting sensor data descriptive of energy use and/or energy production on the farm;
for each of at least a sub-plurality of the farms determining one or more farming industry segments engaged in on the farm, and analyzing at least some of the collected sensor data as relating to the one or more industry segments to obtain a farm-specific analysis of energy management; and
making at least some of the collected data and/or farm-specific analyses available to one or more parties unaffiliated with the farm.

2. The method of claim 1 further comprising monitoring at least some of the collected data to provide a verification of one or more conditions for which a benefit may be provided via one of the one or more unaffiliated parties to a party affiliated with the farm.

3. The method of claim 2, wherein the benefit includes at least one of the following: a savings, a loan, a payment on a lease, a grant, a tax credit, an energy sale, and a payment for a carbon credit.

4. The method of claim 1, further comprising using at least one of the farm-specific analyses to make a farm-specific recommendation of one or more products and/or applications for improving energy management.

5. The method of claim 4, wherein using at least one of the farm-specific analyses comprises using analyses specific to different farms.

6. The method of claim 1, wherein at least some of the collected sensor data is descriptive of renewable energy use and/or renewable energy production.

7. The method of claim 4, wherein the one or more products and/or applications facilitate production of renewable energy.

8. The method of claim 7, wherein the one or more products and/or applications relate to at least one of a wind energy system, a solar energy system, and a biomass energy system.

9. The method of claim 1, further comprising, for one of the farms, storing at least some of the collected data in real time in a web-accessible location available to a party affiliated with the farm.

10-19. (canceled)

20. A method of compiling farm environmental resource data for use in the agricultural industry, the method comprising:
collecting, from each of a plurality of farms representing a plurality of farming industry segments, farm-specific data descriptive of environmental resource management being performed on the farm;
receiving, from a specific one of the farms, a request for a proposal for improving the environmental resource management being performed on the specific farm;
in response to the request, analyzing a portion of the collected data relating to a farming industry segment represented on the specific farm, to determine a scenario for implementing one or more environmental resource management-related products and/or applications on the specific farm; and
making the collected data and scenario available to at least one party unaffiliated with the one of the farms.

21. The method of claim 20 wherein making available includes storing the collected data and scenario in a database and providing said unaffiliated party access to the database via a computer.

22. The method of claim 21 wherein providing said unaffiliated party access includes allowing the unaffiliated party to search and/or compile reports from the database.

23. The method of claim 21 wherein making available includes making it available on a subscription basis.

24. The method of claim 20 wherein one or more financial benefits are obtainable in connection with the one or more environmental resource management-related products and/or applications, and wherein determining a scenario includes including said one or more financial benefits in a cost calculation for the scenario.

25. The method of claim 24, the one or more financial benefits include at least one of the following: a savings, a loan, payment on a lease, a grant, a tax credit, an energy sale, and a carbon credit payment.

26. The method of claim 24, further comprising applying for said one or more financial benefits on behalf of the specific farm.

27. The method of claim 20, wherein the collected data includes data monitored to verify one or more conditions on the farms related to one or more goals of environmental resource and/or energy management.

28. The method of claim 20, wherein the one or more environmental resource management-related products and/or applications facilitate at least one of the following: sustainability, and clean air.

29-48. (canceled)

49. A web-based system for facilitating improvements to farm energy production and/or usage, the system comprising at least one processor and memory configured to:
receive data descriptive of one or more energy-related conditions at a specific farm
receive, from a party affiliated with the specific farm, a request for a scenario for improving energy management on the specific farm;
retrieve, from one or more databases, data descriptive of energy use and/or energy production at a plurality of farms and data descriptive of a plurality of energy-related products and/or applications;
analyze the received and retrieved data to identify one or more energy-related products and/or applications in connection with which one or more benefits may be obtainable by the affiliated party if implemented on the specific farm; and
based on the analysis, output a scenario to the affiliated party for implementing the one or more energy-related products and/or applications and obtaining the one or more benefits.

50. The system of claim 49, further comprising a plurality of sensors configured to:
provide the data descriptive of one or more energy-related conditions at the specific farm; and
provide the data descriptive of energy use and/or energy production at the plurality of farms.
